(19) United States
(12) Patent Application Publication
(10) Pub. No.: US 2010/0058185 A1
(43) Pub. Date: Mar. 4, 2010

(54) DYNAMIC HINTS FOR GUI CONTROL MODES CONTINGENT UPON CONTEXT-DEFINED CONDITIONS

(75) Inventors: Patrick M. Commarford, Louisville, KY (US); James L. Lentz, Austin, TX (US); Lauren M. Shupp, Apex, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/200,746

(22) Filed: Aug. 28, 2008

(51) Int. Cl. G06F 3/00

(52) U.S. Cl. 715/708

(57) ABSTRACT

Embodiments of the present invention provide a method, system and computer program product for assisting a user in a GUI. In an embodiment of the invention method for assisting a user in a graphical user interface (GUI) can include detecting a proximity event in connection with a GUI control of an application in a mode contingent upon a context-defined condition within the application, retrieving an explanation from memory for the mode of the GUI control and contingency of the context-defined condition, and rendering the explanation in association with the mode of the GUI control and the contingency of the context-defined condition.

### BACKGROUND OF THE INVENTION

1. Field of the Invention

The present invention relates to the field of graphical user interface (GUI) control interactions and more particularly to rendering dynamic hints related to GUI controls.

2. Description of the Related Art

The Graphical User Interface, also known as a GUI is a visual front that links an end user of a computer program to the internal workings of the computer program. In general, a GUI provides for visual interface elements which simplify the way the end user interacts with the computer program. A GUI control or a widget is a GUI element that provides a visual element with which an end user interacts to control the operation of the computer program, or through which the state of the computer program can be determined. Of note, some types of GUI controls can assist the end user in avoiding an error condition in the use of a computer program by preventing the end user from actively interacting with the control.

GUI controls especially in a GUI form can feature multiple modes which can dictate the appearance and interaction status of a control. A common control mode is the “disabled” mode (state). In the disabled mode, “graying-out” the appearance of the GUI control can occur when the control is not applicable under certain conditions. For example, a “Save File” GUI control may be unavailable to interact with when a computer program has not yet loaded a file that can be saved. Other common uses of a control mode can include hiding or showing a control in a GUI based upon the context of the GUI. Another common control mode is the “required” mode. In the required mode, a control must be addressed based on a context-defined condition, such as when a text box must receive input. The required mode is typically indicated by an alpha-numeric symbol such as an asterisk displayed adjacent to an associated control.

There are a number of cases in which it may be appropriate to immobilize a GUI control. The first case occurs when a user action should not be accepted because of the mode of an associated control that is visible in the user interface. The second case occurs when a user action is incompatible with the selection mode of the control. The third case occurs when an external condition arises that is not indicated in by the GUI. Oftentimes, a GUI control enters a mode contingent upon a context-defined condition when another control assumes a certain value. Yet, the end user may not understand why the GUI control has entered this mode, or the user may not notice that the context of the GUI has changed causing the GUI control to shift into another mode since the context-defined condition hasn't been met by the end user. Thus, in these circumstances, the GUI control will become immobilized and in most cases appear “non-informative” to the end user because most end users will not be able to understand why the GUI control resulted in an error mode.

One current method attempting to overcome the problem of immobilized GUI controls, has been to leave all controls enabled all the time. In this regard, when an end user specifies an incompatible group of values or data for a GUI control, an error message can be posted. However, this method is problematic such that end users think that the interface “tricked” them into an error state, rather than guiding them regarding allowable actions. Thus, end users become frustrated with error messages that often intrusively disrupt the flow of a task performed.

Other current methods to overcome immobilized GUI controls present visual indicators demonstrating that a control has entered a mode such as required or disabled. Yet, even these techniques fail to provide informative feedback to the end user as to why the GUI control has entered a specific mode. Additionally, these techniques lack guidance for the end user on how to get out of error mode or activate the control, or lack complete guidance about whether a control may be dependent on another control's input.

### BRIEF SUMMARY OF THE INVENTION

Embodiments of the present invention provide a method, system and computer program product for assisting a user in a GUI. In an embodiment of the invention method for assisting a user in a graphical user interface (GUI) can include detecting a proximity event in connection with a GUI control of an application in a mode contingent upon a context-defined condition within the application, retrieving an explanation from memory for the mode of the GUI control and contingency of the context-defined condition, and rendering the explanation in association with the mode of the GUI control and the contingency of the context-defined condition.

In another embodiment, the detected proximity event can include either a selection event or a mouse over event detected by computer program. Furthermore the rendered explanation can include a dynamic hint associated with a selected GUI control to inform a user why the selected GUI control is in the mode contingent upon a context-defined condition. In another embodiment, the method can further include identifying a mode contingent upon a context-defined condition for the GUI control, responsive to the mode preventing a manual directive by the user, rendering a dynamic hint to the user, wherein the dynamic hint explains the contingency of the context-defined condition, and suggests instructions to the user, wherein the instructions explain how to change the mode.

In another embodiment of the invention, a dynamic hint GUI control data processing system can be provided. The system can include a memory, a GUI control displayed in a GUI, a processor, a bus connecting the processor, the memory and the GUI, and GUI dynamic hint logic coupled to the GUI, the logic including program code enabled to detect a proximity event in connection with a GUI control of an application in a mode contingent upon a context-defined condition within the application, retrieve an explanation from memory for the mode of the GUI control and contingency of the context-defined condition, and render the explanation in association with the mode of the GUI control and the contingency of the context-defined condition.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for rendering dynamic hints for GUI control modes contingent upon context-defined conditions;

FIG. 2 is a pictorial illustration of different GUI screenshots configured to render dynamic hints for GUI control modes contingent upon context-defined conditions;

FIG. 3 is a block diagram illustrating a data processing system configured to render dynamic hints for GUI control modes contingent upon context-defined conditions;

FIG. 4 is a table illustrating control data associated with rendering dynamic hints for GUI control modes contingent upon context-defined conditions; and

FIG. 5 is a flow chart illustrating a process for rendering dynamic hints for GUI control modes contingent upon context-defined conditions.

### DETAILED DESCRIPTION OF THE INVENTION

Embodiments of the present invention provide a method, system and computer program product for rendering dynamic hints for GUI controls in a GUI. In accordance with an embodiment of the present invention, a dynamic hint associated with a selected GUI control can be rendered to an end user in order to inform the end user why the selected GUI control is in a mode contingent upon a context-defined condition. In this regard, in response to a proximity event like a mouse over or selection, detected in connection with a GUI control in a mode contingent upon a context-defined condition, a corresponding explanation for the mode can be rendered in association with the selected GUI control. To the extent that the mode depends upon the mode of a different GUI control in the GUI, a visual reference to the different GUI control can be rendered in the GUI. By way of example, the visual reference can include a visual linkage between the GUI controls.

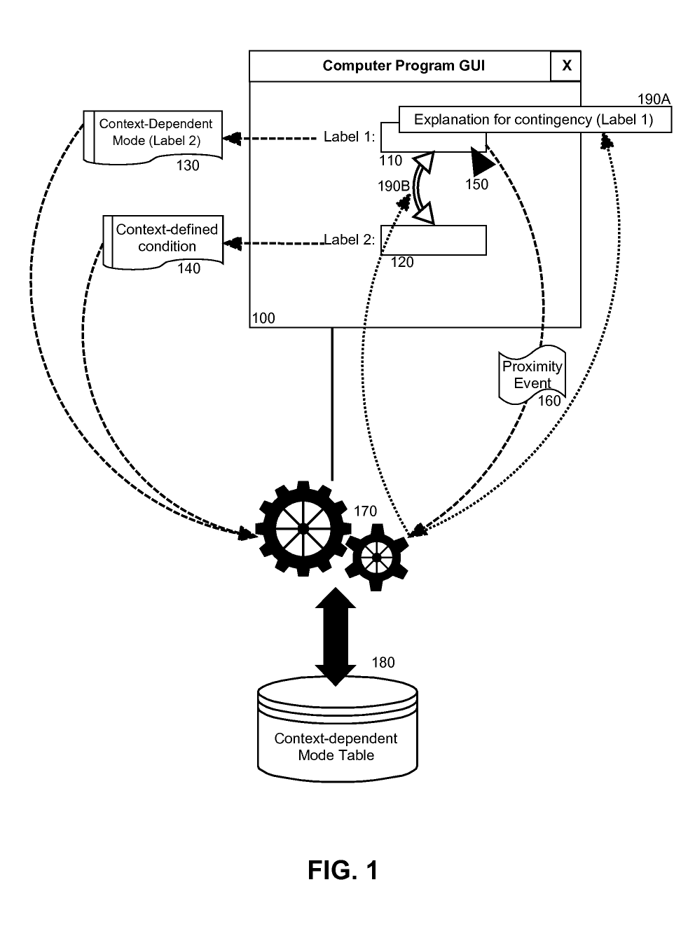

In illustration, FIG. 1 pictorial depicts a process for rendering dynamic hints for GUI control modes contingent upon context-defined conditions. As shown in FIG. 1, a GUI 100 can be provided with one or more GUI controls 110, 120 (only two GUI controls shown for the purpose of illustrative simplicity). Each GUI control can include a corresponding mode 130, 140 that can include either a context-defined condition 140 or a context-dependent mode 130 contingent upon a context-defined condition such as a required state or a disabled state. A mouse pointer 150 or other GUI control selection mechanism can trigger a proximity event 160 such as a selection event or a mouse over event that can be detected by dynamic hint rendering logic 170. In response, the dynamic hint rendering logic 170 can identify in a context-dependent mode table 180 explanations 190A and 190B for the special state 130. The explanations can range from a textual statement of an external condition or context-defined condition pertaining to an underlying computer program 190A, or the explanation can be an animated visual 190B indicating a dependence on the context-defined condition 140 of a different GUI control 120 in the GUI 100. Finally, explanations 190A and 190B can be rendered in association with the GUI control 110 in the mode contingent upon the context-defined condition within the application.

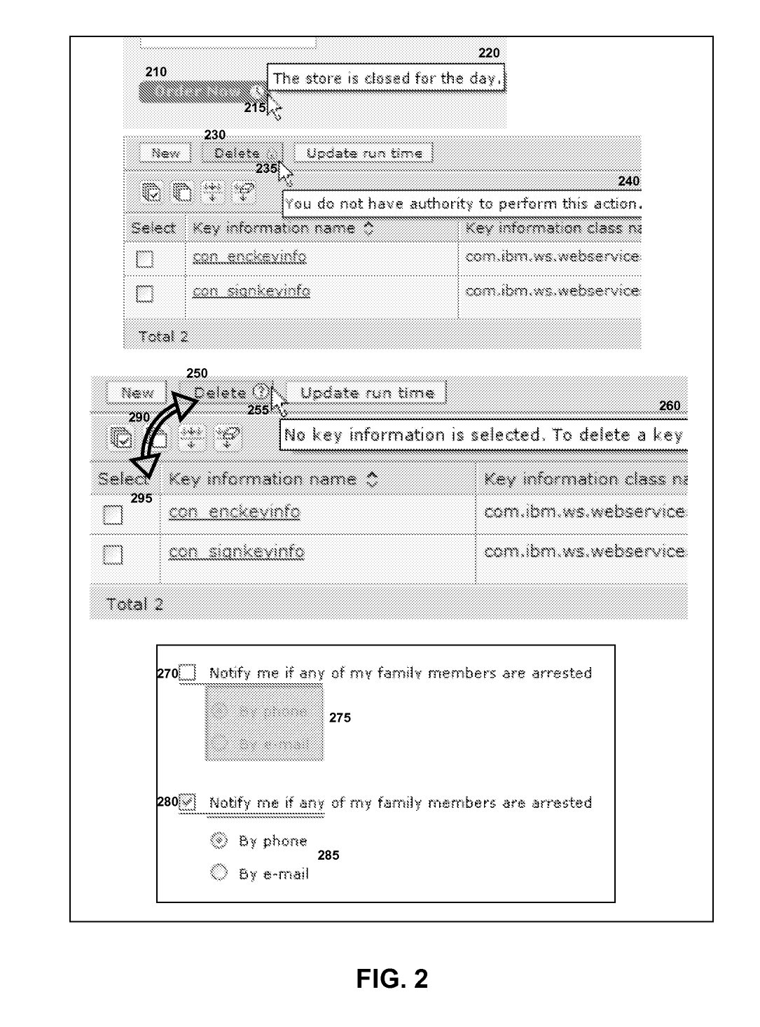

In further illustration, FIG. 2 shows a series GUI screenshots in which each GUI has been configured to render dynamic hints associated with a selected control. As shown in FIG. 2, a control 210 can be ornamented with a hint icon 215 visually situated in association with the control 210 indicating an explanation 220 as to why the control 210 is not available for use. For example, an online store control 210 can appear in a mode contingent upon a context-defined condition within the application such as “disabled” mode with a clock icon 215 indicating an explanation or dynamic hint 220. The explanation or dynamic hint 220 can appear to the user when the user clicks the hint icon, in this case being the clock icon 215. The dynamic hint can indicate the reason why the control is in a mode contingent upon a context-defined condition. The contingency that online orders are not currently being accepted because the store is closed can be rendered to the user in textual, visual or audio form.

In further illustration of FIG. 2, a GUI control 230 could also be ornamented with a hint icon 235 visually situated in association with the control 230 indicating an explanation 240 as to why the control 220 is not available for use. The explanation or dynamic hint 240 can explain the context-defined condition that the user has a lack of authority to perform an action. Notably, it should be recognized by one skilled in the art that any visual/animated or audio indication can render the reason/explanation a control is in a mode (disabled, required, invalid etc.) contingent upon a context-defined condition within an application.

Furthermore in FIG. 2, another example can be provided where an information hint icon 255 can indicate to a user that the control 250 in a contingency mode has some relevant information for the user. Thereafter, hover text explanation 260 can be displayed to render the reason why the control 250 is in a mode contingent upon a context-defined condition and/or how to fulfill the contingency to alter the mode. Alternatively, clicking or otherwise interacting with the control 250 can render a dynamic hint 260 via a pop-up feature or in a designated message area. Additionally, an animated visual hint 290 can be rendered to the user displaying an animated visual link between the control in a special state 250 and another control 295 that may be in a context-defined condition causing the control in the contingency mode 250 to become dependent on the control in the context-defined condition 295. For example, the delete control 250 cannot be selected until a key information name 295 as a context-defined condition is selected first. Notably, different types of animated hints such as an animated visual spotlight on the context-defined condition control 295 or an animated arrow 290 pointing from a first control 250 to a second control 295 that requires user input before the first control can be activated are exemplary features that can be implemented as dynamic animated hints.

Alternatively, a visual indication that the mode of one control is controlling the mode of another control can be communicated to the user through a number of techniques, including the use of icons, borders, shading or any other exaggerated visual cue. For example, when context-defined condition in a control does not occur, such as an unchecked checkbox 270, then a visual colored screen 275 can immobilize the controls implying to the user they are in a mode contingent upon a context-defined condition and that the user must first click the control linked as the context-defined condition 270 in order to mobilize the other controls 275. For example, when the checkbox is clicked 280, the gray screen can “retract” 285 to make available the controls that were previously in a mode contingent upon a context-defined condition. Notably, rendering a dynamic hint to the user can include a visual animated cue that temporarily directs the user's eye from a first control being a context-defined condition to a second control in a mode contingent upon the context-defined condition of the first control. This animated hint can give the user an indication that the two controls are dependent on each other's modes. Thus, the temporary visual cue can identify where the user should focus their attention next by drawing a line pointing from one control to the other control. It should be recognized by one skilled in the art that a control in a mode contingent upon a context-defined condition can represent the status of a control that is determined by the value of another control in a GUI. These contingency modes could include be but not limited to a “disabled” mode, “enabled” mode, “required” mode, “error” mode, or “must be set next” mode.

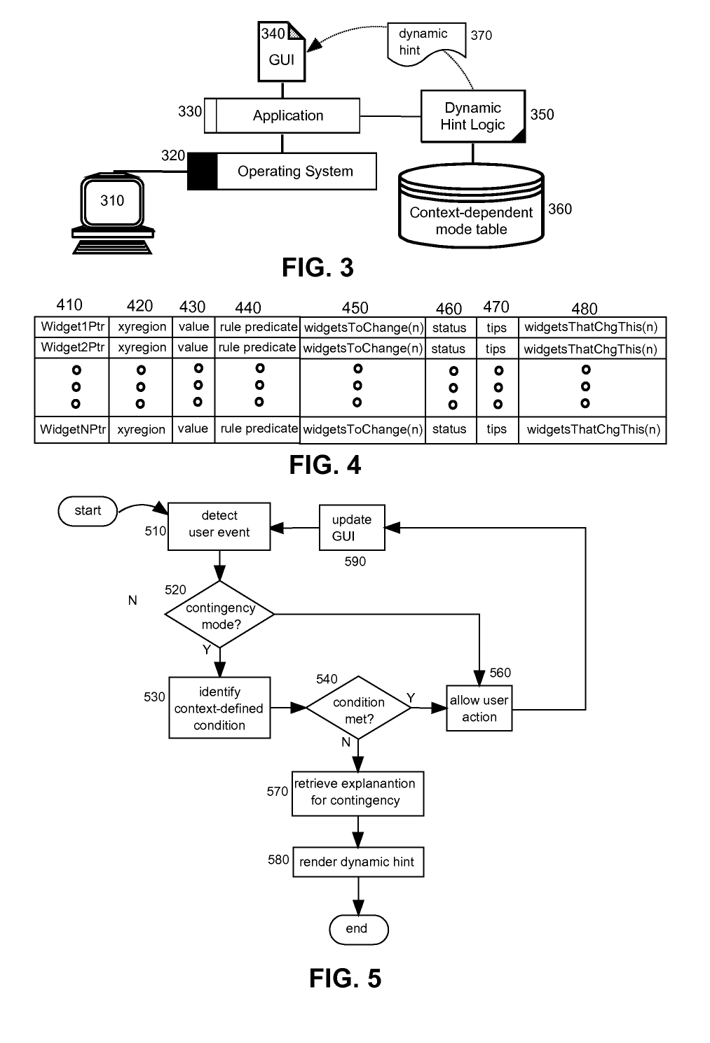

In yet further illustration, FIG. 3 is a block diagram showing a data processing system configured to render dynamic hints for GUI control modes contingent upon context-defined conditions. The data processing system can include a host computing platform 310 including an operating system 320. The operating system 320 can host the execution of a computer program 330 providing a GUI 340. In one aspect of the embodiment, the computer program 330 can be an application or a Web browser rendering a GUI 340 defined by markup. The GUI 340 can include multiple different GUI controls each demonstrating a different mode, including context-dependent modes 130 contingent upon a context-defined condition 140 stored in a context-dependent mode table 360.

Dynamic hint logic 350 can be coupled to the computer program 330. The dynamic hint logic 350 can include program code enabled to detect a proximity event in connection with a selected one of the GUI controls in the GUI 340 in a mode contingent upon a context-defined condition, retrieve an explanation from the context-dependent mode table 360, and render the explanation as a dynamic hint 370 in association with the mode of the GUI control and the contingency of the context-defined condition. The context-dependent mode table 360 can store control data such as references to GUI controls and associated modes 130, 140. The table 360 can include control data such as the region the control occupies on the GUI, the current state of the control, dynamic hints 370 to explain why this control is in a context-dependent mode 130, and a rule predicate defining the context-defined conditions 140 upon which the value of the control causes a state change in context-dependent controls. The table 360 could be used as part of the runtime logic of a GUI exploiting this invention as well as part of control properties in an Integrated Development Environment (IDE) tool used to program user interfaces.

In even yet further illustration, FIG. 4 is a table illustrating control data stored in the context-dependent mode table 360 associated with dynamic hints related to a GUI control in a GUI. In column 410 the control can be identified. Column 420 can depict the region of x-y coordinates the control can occupy in the GUI as a rectangular boundary. Column 430 can depict a value for the identified control, such as a checkbox being checked or unchecked. Next in column 440, a rule predicate can define the context-defined condition upon which the value of a control can cause a mode change in other controls. Column 450 can depict which controls can change according to the given value and predicate rule. Next in column 460, the current mode of a control can be stored. Column 470 can store dynamic hints or any helpful tips to explain why a current control is in a mode contingent upon a context-defined condition within an application. Finally column 480 can depict which controls actually change/control the mode of the current control.

Finally, FIG. 5 is a flow chart illustrating a process for rendering dynamic hints for GUI control modes contingent upon context-defined conditions. Initially, in block 510 a desired user event or action can be detected. A desired action can include a proximity event such as a mouse over event or any selection event or attempt of the user to interact with a control in a GUI that is in a mode contingent upon a context-defined condition. The context-dependent modes can include modes such as disabled state, invalid state, or required state. Next, decision block 520 can determine whether or not the control is in a mode contingent upon a context-defined condition. If not, then in block 560, the user action can be allowed. If the target control identified is in a mode contingent upon a context-defined condition, then in block 530 the context-defined condition can be identified. A context-defined condition can be any condition that affects the function of a control mode. Next in decision block 540, it can be determined whether or not the condition is met. If the condition is met, the desired user action will be allowed in block 560. Thereafter in block 590 the GUI can be updated.

If the condition is not met, then the desired user action will not be allowed since the contingency of the context-defined condition has not been fulfilled by the user. Thus, the unmet condition will lead to block 570 in which an explanation for the contingency of the condition can be retrieved from the context-dependent mode table. Then in block 580, a dynamic hint in association with the mode of the GUI control and the contingency of the context-defined condition can be rendered to the user.

For example, a required mode of a field input from the user could be a phone number. When the field is in a required mode and the field is empty, a context-defined condition is established that prevents user input to other controls, such as a “Save” button that stores the contents of the input field. If the user positions the mouse over this button while in this mode, the condition—text field not empty—is not met and therefore in block 580, a dynamic hint can be rendered to the user. If the user inputs a phone number, the condition is met (i.e. numerical characters are entered—text field not empty) according to decision block 540, the GUI can be displayed in updated form in block 590, thus the “Save” button would now be in a mode that allows it to accept a mouse click input from the user. However in decision block 540, if the data entered by the user, in this case the phone number, is not a valid input due to incorrect data values (i.e. alphabetic characters instead of numeric) or other formatting issues, then a different condition will not be met, therefore in block 580 a different dynamic hint can be rendered to the user.

Notably, rendering a dynamic/animated hint to the user can be a visual hint or audio hint. The visual hint can include ornamenting the control with a hint icon attached to the control. When a user hovers over the hint icon, additional visual hints can be rendered informing the user about the current mode of the control and suggesting how to solve the issue. These visual hints are not limited to merely descriptive text supplementing the hint icon, but also animated visuals that visually direct the user to displaying why the control is in a mode contingent upon a context-defined condition and optionally suggesting instructions on how to change the mode of the control or fulfill the contingency. Furthermore, the animated visual hint can display an animated drawing conveying a link between one control that may be controlling the mode of another control that user is currently attempting to manipulate. In addition, the an animated hint can be supplemented with a audio explanation suggesting additional hints regarding the current state of the control and how to ease the user into solving the issue regarding a special state control.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for assisting a user in a graphical user interface (GUI) comprising:
detecting a proximity event in connection with a GUI control of an application in a mode contingent upon a context-defined condition within the application;
retrieving an explanation from memory for the mode of the GUI control and contingency of the context-defined condition; and,
rendering the explanation in association with the mode of the GUI control and the contingency of the context-defined condition.

2. The method of claim 1 wherein detecting the proximity event is an event selected from the group consisting of a selection event and a mouse over event detected by a computer program.

3. The method of claim 1 wherein the rendered explanation comprises a dynamic hint associated with a selected GUI control to inform a user why the selected GUI control is in the mode contingent upon a context-defined condition.

4. The method of claim 1 further comprising identifying a mode contingent upon a context-defined condition for the GUI control, responsive to the mode preventing a manual directive by the user, rendering a dynamic hint to the user, wherein the dynamic hint explains the contingency of the context-defined condition, and suggests instructions to the user, wherein the instructions explain how to change the mode.

5. A dynamic hint GUI control data processing system comprising:
a memory;
a GUI control displayed in a GUI;
a processor;
a bus connecting the processor, the memory and the GUI; and
GUI dynamic hint logic coupled to the GUI, the logic comprising program code enabled to detect a proximity event in connection with a GUI control of an application in a mode contingent upon a context-defined condition within the application, retrieve an explanation from memory for the mode of the GUI control and contingency of the context-defined condition, and rendering the explanation in association with the mode of the GUI control and the contingency of the context-defined condition.

6. A computer program product comprising a computer usable medium embodying computer usable program code for assisting a user in a graphical user interface (GUI), the computer program product comprising:
computer usable program code for detecting a proximity event in connection with a GUI control of an application in a mode contingent upon a context-defined condition within the application;
computer usable program code for retrieving an explanation from memory for the mode of the GUI control and contingency of the context-defined condition; and,
computer usable program code for rendering the explanation in association with the mode of the GUI control and the contingency of the context-defined condition.

7. The computer program product of claim 6, wherein computer usable program code for detecting the proximity event is an event selected from the group consisting of a selection event and a mouse over event detected by a computer program.

8. The computer program product of claim 6, wherein computer usable program code for the rendered explanation comprises a dynamic hint associated with a selected GUI control to inform a user why the selected GUI control is in the mode contingent upon a context-defined condition.

9. The computer program product of claim 6, wherein computer usable program code further comprises computer usable program code for identifying a mode contingent upon a context-defined condition for the GUI control, responsive to the mode preventing a manual directive by the user, computer usable program code for rendering a dynamic hint to the user, wherein the dynamic hint comprises an explanation for the contingency of the context-defined condition, and instructions to the user, wherein the instructions explain how to change the mode.
